(19) United States
(12) Patent Application Publication
(10) Pub. No.: US 2012/0251917 A1
(43) Pub. Date: Oct. 4, 2012

(54) SOLID OXIDE FUEL CELL COMPRISING NANOSTRUCTURE COMPOSITE CATHODE AND FABRICATION METHOD THEREOF

(75) Inventors: Ji-Won SON, Seoul (KR); Doo Hwan MYUNG, Gyeonggi-do (KR); Jaeyeon HWANG, Seoul (KR); Hae-Weon LEE, Seoul (KR); Byung Kook KIM, Seoul (KR); Jong Ho LEE, Seoul (KR); Hae-Ryoung KIM, Seoul (KR); Ho Il JI, Seoul (KR)

(73) Assignee: KOREA INSTITUTE OF SCIENCE AND TECHNOLOGY, Seoul (KR)

(21) Appl. No.: 13/360,021

(22) Filed: Jan. 27, 2012

(30) Foreign Application Priority Data
Apr. 4, 2011 (KR) 10-2011-0030841

(51) Int. Cl. H01M 8/10; B05D 5/12; B82Y 30/00

(52) U.S. Cl. 429/482; 427/77; 427/78; 977/948

(57) ABSTRACT

Disclosed are a solid oxide fuel cell including: a) an anode support; b) a solid electrolyte layer formed on the anode support; and c) a nanostructure composite cathode layer formed on the solid electrolyte layer, wherein the nanostructure composite cathode layer includes an electrode material and an electrolyte material mixed in molecular scale, which do not react with each other or dissolve each other to form a single material, and a method for fabricating the same. The fuel cell is operable at low temperature and has high performance and superior stability.

### CROSS-REFERENCE TO RELATED APPLICATIONS

This application claims priority under 35 U.S.C. §119 to Korean Patent Application No. 10-2011-0030841, filed on Apr. 4, 2011, in the Korean Intellectual Property Office, the disclosure of which is incorporated herein by reference in its entirety.

### TECHNICAL FIELD

The present disclosure relates to a solid oxide fuel cell and a method for fabricating the same. More particularly, the disclosure relates to a solid oxide fuel cell including a nanostructure composite cathode and thus having improved structural stability and performance and a method for fabricating the same.

### BACKGROUND

A solid oxide fuel cell (SOFC) using solid oxide, or a ceramic material, as an electrolyte has been developed mainly for large-scale power generation owing to higher efficiency than other fuel cells and fuel flexibility allowing for use of various fuels other than hydrogen.

The SOFC for large-scale power generation is usually operated at high temperatures of 800-1,000° C. The operation at such high temperature results in interfacial reactions, deterioration of performance due to difference in thermal expansion of the components such as electrolyte, electrode, sealant, etc., severely restricts the materials and components that can be used, and greatly lowers performance reliability and economic feasibility. Accordingly, researches are intensively carried out to reduce the operation temperature of the SOFC for large-scale power generation down to 700° C. or lower. Further, for easier heat control and reduction of size of high-performance small-sized SOFCs that are studied currently, reduction of the operation temperature is considered an essential task. However, at lower operation temperatures, performance is decreased because of decrease in electrolyte conductivity or electrode activity. Thus, use of new material or change in structure is required.

Since the main component of the SOFC causing loss of performance via electrode polarization is the cathode, the loss of performance caused by the operation at low temperature can be improved by reducing the electrode polarization of the cathode, which in turn can be achieved by increasing the density of active sites for catalytic reaction by reducing the grain size of the cathode microstructure to nanoscale and thus maximizing specific surface area.

The existing SOFC cathode is fabricated via a powder process by preparing a composite electrode powder via a powder process, coating it on an electrolyte by screen printing, spraying, etc. and then sintering at about 1,000° C. (H. G. Jung, et al., Solid State Ionics 179 (27-32), 1535 (2008), H. Y. Jung et al., J. Electrochem. Soc. 154 (5) (2007)).

However, the cathode fabricated via the powder process is disadvantageous in that a nanostructure cannot be achieved since the grain size is limited by the particle size of the raw material (typically from hundreds of nanometers to several micrometers) and, even when the cathode is prepared from nanometer-sized powders, grain growth occurs during the sintering at high temperature.

Although a nanostructure cathode can be successfully achieved by the nano and thin-film process, the present state is merely in the stage of forming a single-phase thin-film cathode and characterizing its electrochemical performance. The single-phase electrode has the following problems: difference in thermal expansion coefficient with the electrolyte material, structural instability of the nanostructure at the SOFC operation temperature, making it difficult to increase thickness, and severe degradation of the cathode with time (H. S. Noh et al., J. Electrochem. Soc. 158 (1), B1 (2011)).

### SUMMARY

The present disclosure is directed to providing a solid oxide fuel cell (SOFC) having improved structural stability at the SOFC operation temperature with the problem of difference in thermal expansion coefficient from that of the electrolyte material by forming a nanostructure electrolyte-cathode composite thin film of high catalytic activity by thin-film deposition, and a method for fabricating the same.

The present disclosure is also directed to providing a high-performance solid oxide fuel cell having a gradient structure wherein the composition or porosity changes gradually from the electrolyte toward the upper portion of the cathode by forming the nanocomposite cathode thin film with multiple layers to prevent defects caused by the difference in physical properties of the materials of the electrolyte and the cathode, and a method for fabricating the same.

In one general aspect, the present disclosure provides a solid oxide fuel cell including: a) an anode support; b) a solid electrolyte layer formed on the anode support; and c) a nanostructure composite cathode layer formed on the solid electrolyte layer, wherein the nanostructure composite cathode layer includes an electrode material and an electrolyte material mixed in molecular scale, which do not react with each other or dissolve each other to form a single material.

In another general aspect, the present disclosure provides a method for fabricating a solid oxide fuel cell, including: 1) forming a solid electrolyte layer on an anode support; and 2) forming a nanostructure composite cathode layer wherein an electrolyte material and an electrode material are mixed in molecular scale on the solid electrolyte layer.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 schematically shows a gradient-structured nanocomposite electrode device according to an exemplary embodiment;

FIG. 2 shows SEM images showing surface morphologies of (a) LSC and (b) LSC-GDC layers deposited at room temperature and P_{amb}=13.33 Pa and then post-annealed at 650° C. in Example 1;

FIG. 3 shows SEM images showing (a) surface morphology and (b) cross-sectional microstructure of an LSC cathode and those of an LSC-GDC cathode [(c) and (d)] deposited at Tₛ=700° C. and P_{amb}=13.33 Pa;

FIG. 4 shows surface morphologies of LSC-GDC deposited at (a) P_{amb}=13.33 Pa, (b) P_{amb}=26.66 Pa and (c) P_{amb}=39.99 Pa (Tₛ=700° C.);

FIG. 5 shows cross-sectional microstructure of a gradient-structured thin-film (GSTF) cathode;

FIG. 6 shows (a) low-magnification high-angle annular dark field (HAADF) TEM and (b) high-magnification bright field (BF) TEM images of an LSC-GDC layer deposited at Tₛ=700° C. and P_{amb}=26.66 Pa (layer 1), and (c) low-magnification HAADF and (d) high-magnification BF TEM images of an LSC-GDC layer deposited at Tₛ=700° C. and P_{amb}=39.99 Pa (layer 2) [Some of equiaxed grains are indicated with arrows in (b) and (d).];

FIG. 7 shows (a) electron beam diffraction pattern and (b) glancing-angle XRD (GAXRD) pattern of an LSC-GDC layer deposited at Tₛ=700° C. and P_{amb}=39.99 Pa (layer 2) [Indexing was based on GDC (#75-0161) and LSC (#87-1081) of JCPDS];

FIG. 8 shows (a) current-voltage-power (I-V-P) curves of a cell having a GSTF cathode and a cell having a single-phase cathode measured at 650° C., (b) impedance spectrum (IS) of a cell having a GSTF cathode, and (c) IS of a cell having a single-phase cathode;

FIG. 9 shows cross section and low-magnification surface morphology of an LSC single-phase cathode [(a) and (b)], cross section and low-magnification surface morphology of a GSTF cathode after cell test [(c) and (d)], and (e) surface morphology of an LSC single-phase cathode before cell test;

FIG. 10 shows cross-sectional structure of an SOFC single cell fabricated in Example 2 according to the present disclosure;

FIG. 11 shows XRD spectrum of a single cell fabricated in Example 2 according to the present disclosure;

FIG. 12 shows (a) surface morphology and (b) cross-sectional microstructure of an LSM-YSZ/LSC gradient-structured thin-film cathode;

FIG. 13 shows IS of cells having a gradient-structured composite cathode (◯) and a single-phase LSM cathode (□); and

FIG. 14 shows I-V-P curves of cells having a gradient-structured composite cathode (◯) and a single-phase LSM cathode (□).

### DETAILED DESCRIPTION OF EMBODIMENTS

The advantages, features and aspects of the present disclosure will become apparent from the following description of the embodiments with reference to the accompanying drawings, which is set forth hereinafter. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. The terminology used herein is for the purpose of describing particular embodiments only and is not intended to be limiting of the example embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present disclosure will be described in detail.

The present disclosure relates to a solid oxide fuel cell (SOFC) comprising a nanostructure electrolyte-electrode composite cathode layer wherein an electrode material and an electrolyte material are mixed in molecular scale to overcome the difference in thermal expansion coefficients and structural instability at the SOFC operation temperature, and a method for fabricating the same.

The present disclosure provides a solid oxide fuel cell comprising: a) an anode support; b) a solid electrolyte layer formed on the anode support; and c) a nanostructure composite cathode layer formed on the solid electrolyte layer, wherein the nanostructure composite cathode layer comprises an electrode material and an electrolyte material mixed in molecular scale, which do not react with each other or dissolve each other to form a single material.

In an exemplary embodiment of the present disclosure, the electrode material of the composite cathode layer may be selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate, but is not limited thereto.

And, the electrolyte material may be selected from a group consisting of an oxygen ion conductor, e.g., doped zirconia such as yttria-stabilized zirconia (YSZ), scandia-stabilized zirconia (ScSZ), etc., doped ceria such as gadolinia-doped ceria (GDC), samaria-doped ceria (SDC), etc., and a ceramic proton conductor, e.g., doped barium zirconate (BaZrO₃), barium cerate (BaCeO₃), etc., but is not limited thereto.

The electrode material and the electrolyte material do not react with each other or dissolve each other at the fabrication temperature of the composite target and thin film or at the operation temperature of the device to form a single material.

In an exemplary embodiment of the present disclosure, the proportion of the electrode material and the electrolyte material of the composite cathode layer may be from 2:8 to 8:2, specifically from 3:7 to 7:3. Within this range, the nanocomposite material according to the present disclosure may have interconnectivity (U. P. Muecke, S. Graf, U. Rhyner, L. J. Gauckler, Microstructure and electrical conductivity of nanocystalline nickel- and nickel oxide/gadolinia-doped ceria thin films. Acta Mater. 56 (2008) 677-687).

The anode support may comprise a material selected from a group consisting of a material that forms a cermet composite of nickel with the electrolyte material during operation of a fuel cell, such as NiO-YSZ, NiO—ScSZ, NiO-GDC, NiO-SDC NiO-doped BaZrO₃, etc. and a material that forms a cermet composite of an anode catalyst material with the electrolyte material, such as Ru, Pd, Rd, Pt, etc.

The composite formed at 200-1,000° C. has a grain size of 100 nm or smaller. Such a small grain size cannot be achieved with the existing powder process and allows for high catalytic activity.

In another exemplary embodiment of the present disclosure, the solid oxide fuel cell may further comprise a single-phase current collecting layer on the composite cathode layer or may further comprise a buffer layer between the electrolyte layer and the composite cathode layer.

In an exemplary embodiment of the present disclosure, the composite cathode layer may comprise two or more layers. Specifically, the composite cathode layer may have a porosity-gradient structure with porosity increasing from the side contacting with the electrolyte layer toward the upper portion or a composition-gradient structure with the content of the electrode material increasing from the side contacting with the electrolyte layer toward the upper portion. Since the multi-layered gradient structure allows for gradual change in structure and composition between the electrolyte and the cathode, structural stability may be further improved. Especially, it is effective in improving long-term stability and reliability of an SOFC operating at high temperatures.

The present disclosure also provides a method for fabricating a solid oxide fuel cell, comprising: 1) forming a solid electrolyte layer on an anode support; and 2) forming a nanostructure composite cathode layer wherein an electrolyte material and an electrode material are mixed in molecular scale on the solid electrolyte layer.

In an exemplary embodiment of the present disclosure, the composite cathode layer may be formed by pulsed laser deposition (PLD) or sputter deposition. Further, the cathode layer may be formed by electron beam evaporation deposition, thermal evaporation deposition, chemical vapor deposition (CVD), electrostatic spray deposition, or the like. Alternatively, rather than depositing source powder, a deposition method whereby deposition particles are atomized/molecularized to form plasma to allow for mixing in atomic/molecular scale may also be employed.

Specifically, when the pulsed laser deposition (PLD) is employed, the composite cathode layer may be deposited at 200-1,000° C. and pressure of 10 Pa or higher. In order to ensure uniform deposition by improving mobility of the deposited particles on the deposition surface and to ensure adhesion and crystallinity of the resulting thin film, the deposition temperature needs to be at least 200° C. When the deposition temperature is not so high, the adhesion and crystallinity of the thin film may be further improved by post-annealing. Meanwhile, when the composite cathode layer is formed, the deposition temperature should not exceed 1,000° C. When the deposition temperature exceeds 1,000° C., loss of the nanoparticle characteristics of the thin film may occur due to excessively large gran size, as well as undesirable reaction with the electrolyte material, deterioration of the deposition apparatus, or the like.

And, when the composite cathode layer is formed, the deposition is performed at a temperature higher than room temperature and at a pressure of 10 Pa or higher to obtain the porous structure. When the deposition temperature is higher than room temperature but the deposition pressure is below 10 Pa, a dense thin film is formed owing to increased mobility of the deposited material on the substrate surface. As a result, the porous structure desired for the SOFC electrode cannot be attained.

In another exemplary embodiment of the present disclosure, a single-phase current collecting layer may be formed on the composite cathode layer after the composite cathode layer is formed.

In another exemplary embodiment of the present disclosure, a buffer layer may be formed between the electrolyte layer and the composite cathode layer before the composite cathode layer is formed.

In an exemplary embodiment of the present disclosure, the composite cathode layer may comprise two or more layers. Specifically, the composite cathode layer may have a porosity-gradient structure with porosity increasing from the side contacting with the electrolyte layer toward the upper portion. For example, the porosity-gradient structure may be formed by forming an n-th composite cathode layer (n is an integer 1 or larger) and then forming an (n+1)-th composite cathode layer with porosity higher than that of the n-th composite cathode layer by increasing deposition pressure, or by forming an n-th composite cathode layer (n is an integer 1 or larger) and then forming an (n+1)-th composite cathode layer with porosity higher than that of the n-th composite cathode layer by lowering deposition temperature.

Also, the composite cathode layer may have a composition-gradient structure with the content of the electrode material increasing from the side contacting with the electrolyte layer toward the upper portion. Specifically, the composition-gradient structure may be formed by controlling the composition of a composite target comprising the electrode material and the electrolyte material when depositing the composite cathode layer using the composite target, or by controlling laser power, pulse or sputter power for each electrode target material and electrolyte target material when depositing the composite cathode layer using the target materials.

In another exemplary embodiment of the present disclosure, post-annealing may be conducted after the composite cathode layer is formed in order to improve adhesion and crystallinity of the thin film.

Hereinafter, exemplary embodiments will be described in detail with reference to the accompanying drawings.

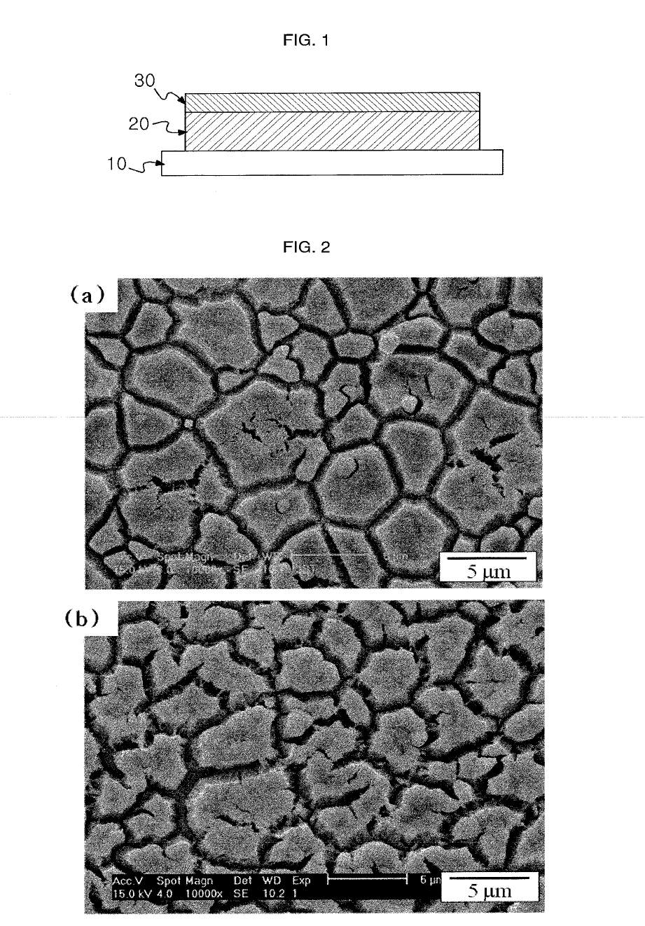

FIG. 1 schematically shows a gradient-structured nanocomposite electrode device according to an exemplary embodiment, comprising an electrolyte layer 10, a composite cathode layer 20 and a current collecting layer 30. The electrolyte layer 10 may comprise a solid electrolyte for an SOFC, and may be a thick electrolyte layer with thickness of several micrometers or a thin electrolyte layer with thickness 1 μm or smaller. Between the electrolyte layer 10 and the composite cathode layer 20, a buffer layer may be formed to prevent reaction between the electrolyte layer and the composite cathode layer or to improve adhesion.

The composite cathode layer 20 may comprise one or more layer(s). When it comprise 2 or more layers, porosity and composition of the electrode material may increase from the interface contacting with the electrolyte layer toward the uppermost portion of the composite cathode layer. That is to say, when the composite cathode layer comprises 2 or more layers, a layer close to the electrolyte layer may be denser and have a higher electrolyte content than the layer formed thereabove, and the layer near the uppermost portion of the composite cathode layer may be more porous and have a higher electrode material content than the layer formed therebelow. Specifically, 1) the composition may be constant and only the porosity may increase toward the upper portion, 2) the porosity may be constant and only the electrode material content may increase toward the upper portion, or 3) both the porosity and the electrode material may increase toward the upper portion.

The gradient structure may be formed as follows. In order to increase the porosity toward the upper portion while keeping the composition constant, deposition pressure is increased toward the upper portion. When the deposition pressure is increased, the deposited particles are more likely to collide with each other in plasma state before they reach the substrate. Thus, it is easier for them to form aggregates than at low deposition pressure. Further, since the particles lose considerable energy they reach the substrate, they cannot easily rearrange on the substrate. As a result, a loosely packed film with larger grain size and porosity is formed.

The porosity-gradient structure may also be obtained by gradually lowering the deposition temperature. As the deposition temperature is lowered, since the particles reaching the substrate cannot easily rearrange on the substrate, a loosely-packed film with higher porosity is formed as compared to when the deposition temperature is high. In order to change the composition toward the upper portion while keeping the porosity constant, the target composition is changed while keeping the deposition condition (deposition temperature and deposition pressure) constant. In order to change both the porosity and composition, both the deposition condition (deposition temperature and deposition pressure) and the target composition are changed.

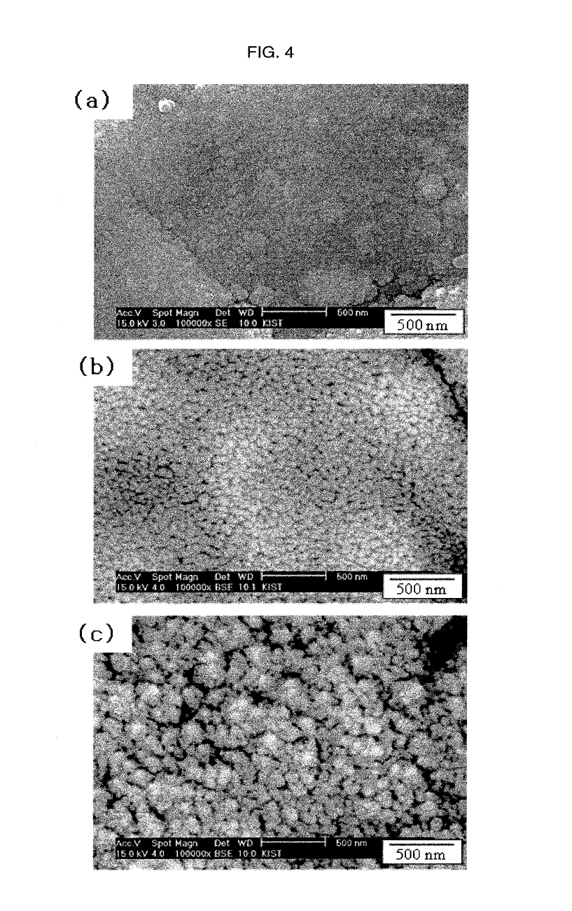

FIG. 4 (a)-(c) show scanning electron microscopic images of surface morphologies of composite cathode layers formed by depositing LSC-GDC (1:1) at 700° C. on an electrolyte by PLD while increasing deposition pressure from 13.33 Pa to 26.66 Pa and 39.99 Pa. It can be seen that the porosity increases gradually as the deposition pressure is increased.

Since a uniform structure with equiaxed grains rather than columnar-shaped grains can be obtained when the reactants not reacting with or dissolving each other are deposited simultaneously, structural stability at high temperature can be improved by preventing aggregation and electrode performance can be enhanced by increasing the number of electrolyte/electrode/air interfaces.

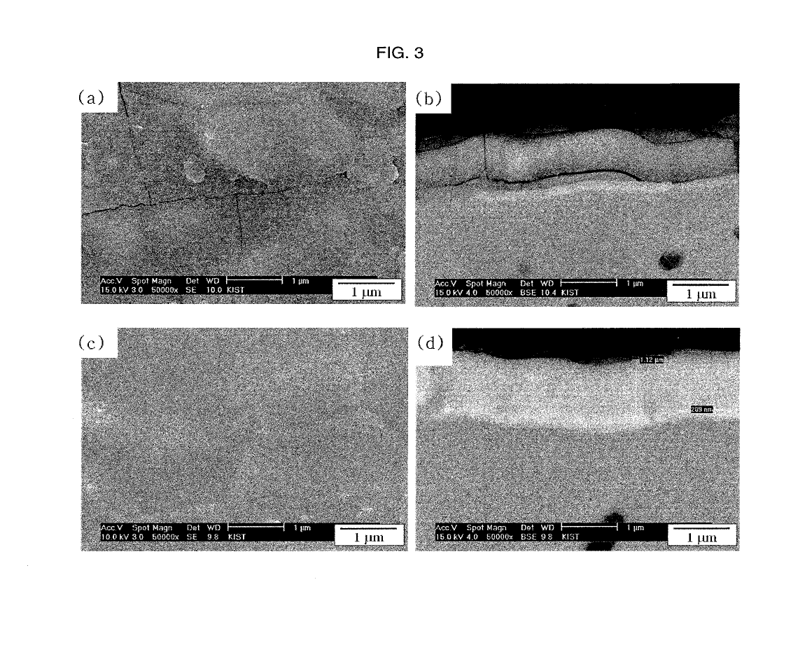

The composite cathode can improve structural reliability of the cathode even with a single layer by reducing the difference in thermal expansion of the electrolyte and the cathode. FIG. 3 compares surface morphology and cross-sectional microstructure of a cathode thin film made of a single electrode material (LSC) [(a) and (b)] with those of a cathode thin film made of 1:1 composite of an electrode material (LSC) and an electrolyte material (GDC) [(c) and (d)]. Both thin films were deposited at 700° C. and 13.33 Pa by PLD. The 200-nm-thick GDC layer was formed on the YSZ electrolyte as a reaction buffer layer. It is observed that cracks occurred in the LSC single-phase thin film due to the difference in thermal expansion coefficients (LSC ˜23 ppm, YSZ ˜11 ppm, GDC ˜12 ppm). Especially, cracking is prominent at the interface between the cathode and the electrolyte. In contrast, cracking was not observed in the LSC-GDC film, since the electrolyte material GDC reduced the difference in thermal expansion coefficient with the electrolyte. Also, the interfacial strength was maintained. Such improvement in structural stability can be further enhanced when the composite cathode is formed to have a gradient structure as described above.

The current collecting layer 30 in FIG. 1 is a highly conductive layer comprising a single electrode material and serves to facilitate current collection at the cathode. When the deposition is performed at room temperature, post-annealing may be conducted to achieve the porous structure. And, when the deposition is performed at temperatures above room temperature, the pressure is increased to 10 Pa or higher to achieve the porous structure. The current collecting layer may be omitted if the uppermost portion of the composite cathode layer can serve as the current collecting layer enough.

### EXAMPLES

The examples and experiments will now be described. The following examples and experiments are for illustrative purposes only and not intended to limit the scope of this disclosure.

### Example 1

### LSC-GDC Composite Electrode

NiO-YSZ composite powder was compacted and sintered according to the existing powder process. On the resulting anode support, a NiO-YSZ anode layer with a smaller particle size than the anode support was formed by screen printing. Then, a YSZ electrolyte layer was formed thereon by screen printing. Following sintering at 1,400° C. for 3 hours, a thick-film electrolyte (−8-μm thick YSZ) of an anode-supported SOFC was completed. On 8-μm thick YSZ electrolyte on NiO-YSZ anode supports, 200-nm thick GDC as a buffer layer was deposited by PLD between the LSC-based cathode and the YSZ electrolyte. Deposition temperature was 700° C. and deposition pressure was 6.67 Pa.

To investigate the effect of the deposition parameters and materials change, 1 μm-thick cathode layers were deposited by PLD under various deposition conditions and their microstructures were observed by using scanning electron microscopy (SEM). For PLD, a KrF excimer laser (A=248 nm) was used as a laser source. The laser fluence at the target surface was approximately 3 J/cm², and the target to substrate distance was fixed at 5 cm.

Target materials, deposition substrate temperatures (Tₐ), ambient deposition pressures (P_{amb}, oxygen), and post-annealing conditions are listed in Table 1. The LSC target was prepared by sintering a compacted LSC (La_{0.6}Sr_{0.4}CoO_{3-δ}) powder pellet at 1,200° C. for 3 hours. The La_{0.6}Sr_{0.4}CoO_{3-δ}—Ce_{0.9}Gd_{0.1}O_{2-δ}(LSC-GDC) composite target was prepared by sintering a compacted pellet of LSC and GDC powder mixture (mixing volume ratio=1:1) at 1,300° C. for 5 hours.

TABLE 1

| | Deposition | Ambient oxygen | Post- |
|---|---|---|---|
| | temperature | pressure | annealing |
| Target materials | (° C.) | (Pa) | condition |
| La_{0.6}Sr_{0.4}CoO_{3-δ}(LSC) | Room temp. | 13.33 | 650° C., 1 hr |
| | 700 | 13.33, 26.66, | No |
| | | 39.99 | |
| La_{0.6}Sr_{0.4}CoO_{3-δ} + | Room temp. | 13.33 | 650° C., 1 hr |
| Ce_{0.9}Gd_{0.1}O_{2-δ} | 700 | 13.33, 26.66, | No |
| (LSC-GDC mixing vol. | | 39.99 | |
| ratio = 1:1) | | | |

An anode-supported cell with an 8 μm-thick YSZ electrolyte/200 nm-thick GDC buffer layer was used as the platform as same as the morphology observation. A gradient-structured cathode consisted of three layers. The first layer contacting GDC was a 1 μm-thick LSC-GDC composite layer deposited at Tₛ=700° C. and P_{amb}=26.66 Pa, the second layer was a 1 μm-thick LSC-GDC composite layer deposited at Tₛ=700° C. and P_{amb}=39.99 Pa, and the third (top) layer was a 2 μm-thick LSC single-phase layer deposited at room temperature and P_{amb}=13.33 Pa and then post-annealed at 650° C. in air.

The first two composite layers were subsequently deposited at 700° C. without breaking the vacuum. The third single-phase layer was deposited after lowering the substrate temperature and breaking the vacuum. For comparison, a cell with a 4 μm-thick single-phase LSC cathode was fabricated by depositing LSC at room temperature and P_{amb}=13.33 Pa and then post-annealing it at 650° C. in air.

Both cells were subjected to impedance spectrum (IS) and current-voltage-power (I-V-P) from 600 to 450° C. at intervals of 50° C. and then temperature was raised to 600° C. again to check the consistency of the cell performance after a test cycle. Afterwards, the cell temperature was raised to 650° C. and impedance was monitored for 12 hours. Electrochemical characterization was done by using a Solartron impedance analyzer with an electrochemical interface (SI1260 and SI1287). In-depth microstructural analysis and compositional analysis were performed on the cathode layers of the tested cell by transmission electron microscopy (TEM) with and energy-dispersive X-ray spectroscopy (EDS). The cross-sectional TEM specimen of the cathode was prepared by using a dual beam focused ion beam (FIB) apparatus.

In FIG. 2, top-view SEM images of the LSC and LSC-GDC layers deposited at room temperature and P_{amb}=13.33 Pa and then post-annealed are displayed. They show typical morphology and retain the characteristics of the cathode layer which was loosely packed during the deposition and densified during the post-annealing. Especially, the cathode microstructures exhibit chasms which reflect the grain boundaries of the electrolyte.

Under this deposition condition, the energy of the deposited material is low at the surface due to the high ambient deposition pressure and low substrate temperature at the deposition stage, thus the interfacial adhesion is not strongly developed. The main adhesion strength of this structure is developed during the post-annealing without any assistance of additional kinetic or thermal energy of the deposited materials. Thus, the interfacial adhesion is inevitably weak.

Microstructure Analysis Result

The thin-film type cathode prepared as described above has interfacial strength problem when the thickness of the cathode increases. Therefore, although low-temperature and high-ambient pressure deposition and post-annealing is a simple and easy method to obtain a nanoporous microstructure, it is not the optimal process to produce thin-film-processed cathodes with a desirable microstructural stability.

Raising the substrate temperature during the deposition can be a solution to improve the interfacial strength. In FIG. 3, the LSC and LSC-GDC cathodes deposited at Tₛ=700° C. and P_{amb}=13.33 Pa are shown. When the cathode film was deposited at high temperature, the film coverage was more uniform and the interfacial strength was improved. This is because the molecular scale deposits could rearrange at the substrate surface owing to the high substrate temperature and the adhesion was enhanced during the deposition stage.

However, when the deposition was performed at high temperature, the LSC single-phase layer is more significantly subjected to the thermal expansion coefficient (TEC) mismatch stress unlike the case shown in FIG. 2 because the rigidity of the film increases due to increased density.

Seeing FIGS. 3 (a) and (b), it is clear that the LSC layer has cracks due to TEC mismatch, and the interfacial failures are obvious. Increasing the porosity of the film may mitigate the cracking of the film by decreasing the rigidity of the film; however, the cracks and interfacial failures in the LSC films were persistently observed in spite of the ambient pressure increment up to 39.99 Pa. The LSC-GDC composite thin film, on the contrary, did not show any obvious defects.

Identification of Gradient Structure

It can be seen from the above microstructure analysis that mixing of the two materials, LSC and GDC, is effective to reduce the discrepancy of TEC between the electrolyte and the cathode layer. This result indicates that increasing the substrate temperature can be a possible solution to improve the interfacial adhesion but an adjustment should be conducted to mitigate the TEC mismatch, like employing the composite approach shown in FIGS. 3 (c) and (d). One can notice that, when comparing FIG. 2 (b) and FIG. 3 (c), although both films were deposited at the same P_{amb}, the porosity of the deposited film shown in FIG. 3 (c) is substantially decreased owing to the enhanced surface rearrangement of materials at the high substrate temperature during the deposition stage.

The ambient deposition pressure should be raised further to realize a more porous structure at a high deposition temperature. In FIG. 4, the surface morphologies of LSC-GDC deposited at P_{amb}=13.33, 26.66 and 39.99 Pa (Tₛ=700° C.) are displayed. As the ambient pressure increased from 13.33 to 39.99 Pa, a more porous structure was obtained. Because scattering and clustering of the ablated target materials increases as the ambient pressure is raised, the ablated materials lose kinetic energy and land on the substrate with a less degree of surface rearrangement. As a consequence, a more porous microstructure is produced at a higher ambient deposition pressure. This result suggests that the degree of porosity of the composite cathode can be controlled by changing the ambient deposition pressure.

Based on single layer observation, a gradient-structured thin-film cathode (hereinafter, GSTF cathode) was formed as follows. The first layer (layer 1) contacting GDC was a 1 μm-thick LSC-GDC composite layer deposited at Tₛ=700° C. and P_{amb}=26.66 Pa. The second layer (layer 2) was a 1 μm-thick LSC-GDC composite layer deposited at Tₛ=700° C. and P_{amb}=39.99 Pa. The inventors intended to build composite layers with increasing porosity along the direction toward the cathode surface by the two distinctive composite layers.

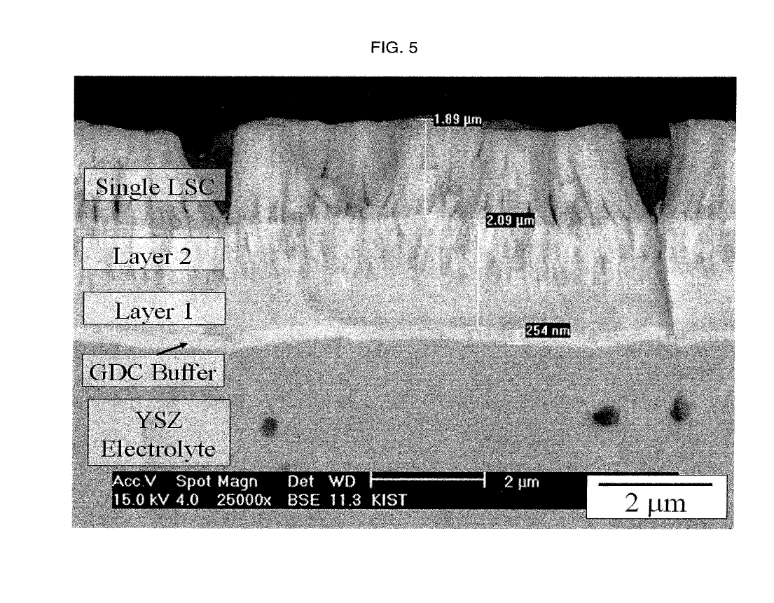

The third (top) layer was a current collecting layer which has the highest porosity and conductivity. A 2 μm-thick LSC single-phase layer was deposited at room temperature and P_{amb}=13.33 Pa and then post-annealed at 650° C. in air. The thickness of the top layer was determined to be below 3 μm which shows less degradation. In FIG. 5, the cross-sectional microstructure of the GSTF cathode is displayed. Three layers are clearly discernible.

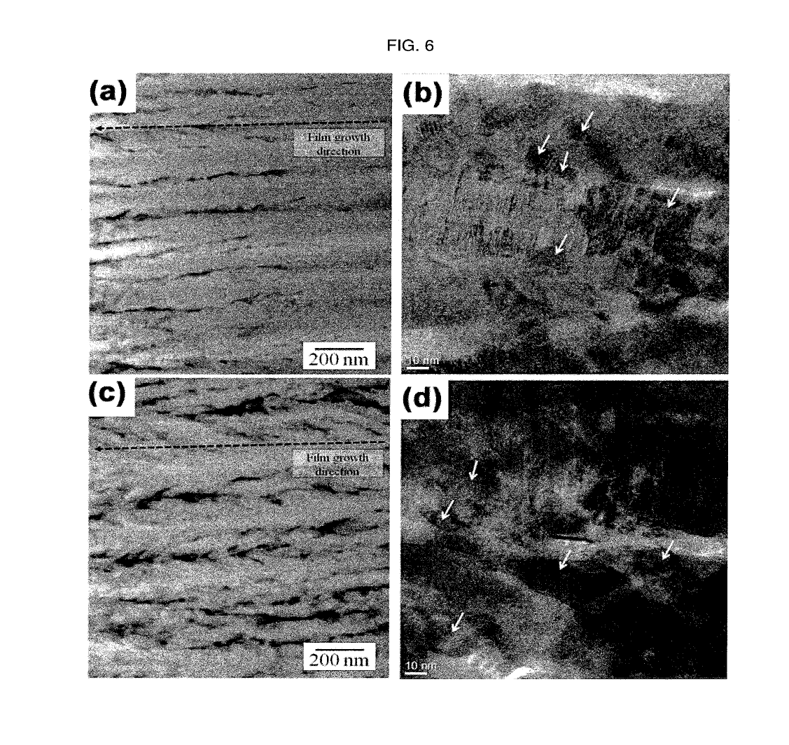

In FIG. 6, TEM images of each composite layer are shown. FIGS. 6 (a) and (b) are a low magnification high-angle annular dark field (HAADF) image and a high magnification bright field (BF) TEM image of layer 1, respectively, and FIGS. 6 (c) and (d) are those of layer 2, respectively.

As shown in HAADF images of FIGS. 6 (a) and (c), layer 1 has lower porosity than layer 2, as was predicted from FIG. 4. Both shows vertical void structures along the deposition direction and denser column-shape domains. The column-like growth of the domain in the thin film is a characteristic of thin-film deposition and it originates from the limited surface mobility of the deposited materials.

Polycrystalline Nature

One unique characteristic of the present disclosure is the polycrystalline nature of the column. High-temperature deposition of a single-phase thin film yields single-crystal columnar grains. On the contrary, the columnar domains of both layers exhibited a polycrystalline structure consisting of round-shaped (equiaxed) grains. The shape of the grains and the polycrystalline characteristic of the column of each layer are well shown in the high-resolution BF images displayed in FIGS. 6 (b) and (d). A similar polycrystalline nature of the film was reported in thin-film NiO-YSZ composites as well. This LSC-GDC composite film provides another example that the thin films deposited from the composite of two immiscible phases yield a non-columnar grain structure.

From the TEM observation, the microstructure of the composite layer which is deposited at a high substrate temperature and a high ambient deposition pressure can be summarized as follows. Macroscopically, the composite layer consists of columnar domains which are separated by vertical voids. Microscopically, the columnar domains are composed of equiaxed grains.

Seeing the HAADF images FIGS. 6 (a) and (c), it appears that the separation width of the columnar domains and the packing density of the grains in the columnar domain are dependent on the ambient deposition pressure. The composite film deposited at higher ambient pressure (layer 2) exhibited wider separation of the columnar domains and looser packing of grains in the columnar domain. As previously mentioned, this microstructure dependency on the ambient deposition pressure enables to control the porosity of the thin-film-processed composite layer.

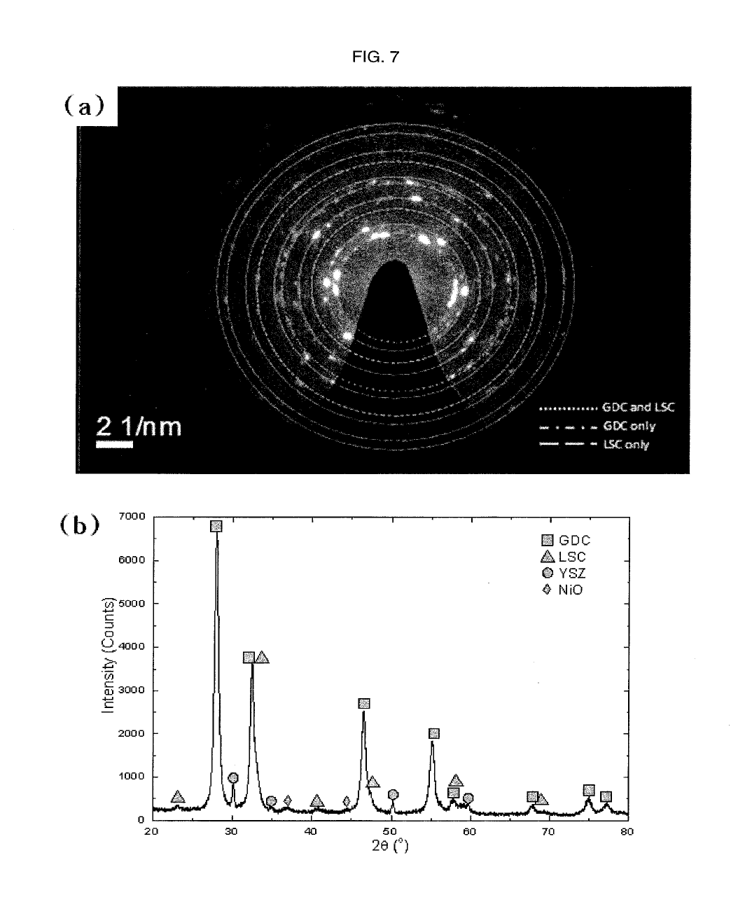

In terms of the composition of the composite layer, the material distribution analyzed by TEM-EDS areal mapping revealed homogeneous distribution of LSC and GDC, which implies that the films are mixed well in nano-scale. However, complete identification of the material of each grain was not possible because the grain size was a few tens of nanometers as shown in FIGS. 6 (c) and (d), and the EDS resolution could not identify the materials of each grain in this fine scale at the ˜50 nm-thick TEM specimen. Therefore, the inventors performed both electron beam diffraction and glancing angle X-ray diffraction (GAXRD) on the composite layer. The electron beam diffraction result is shown in FIG. 7 (a) and the GAXRD result is shown in FIG. 7 (b).

It is clear that the composite film is polycrystalline. Both data were indexed using GDC (#75-0161) and LSC (#87-1081) of JCPDS. Unlike the LSM-YSZ nanocomposite, it is difficult to separate the diffractions by LSC and GDC because the main diffractions of LSC overlapped with those of GDC, and only very weak diffractions of LSC were discernible from those of GDC. However, both electron beam and X-ray diffractions indicate that there are weak though distinctive diffraction rings or peaks that only originate from LSC along with the overlapped diffractions and diffractions from GDC. Thus, it could be concluded that crystalline nano-scale composites were obtained.

Cell Performance and Long-Term Stability

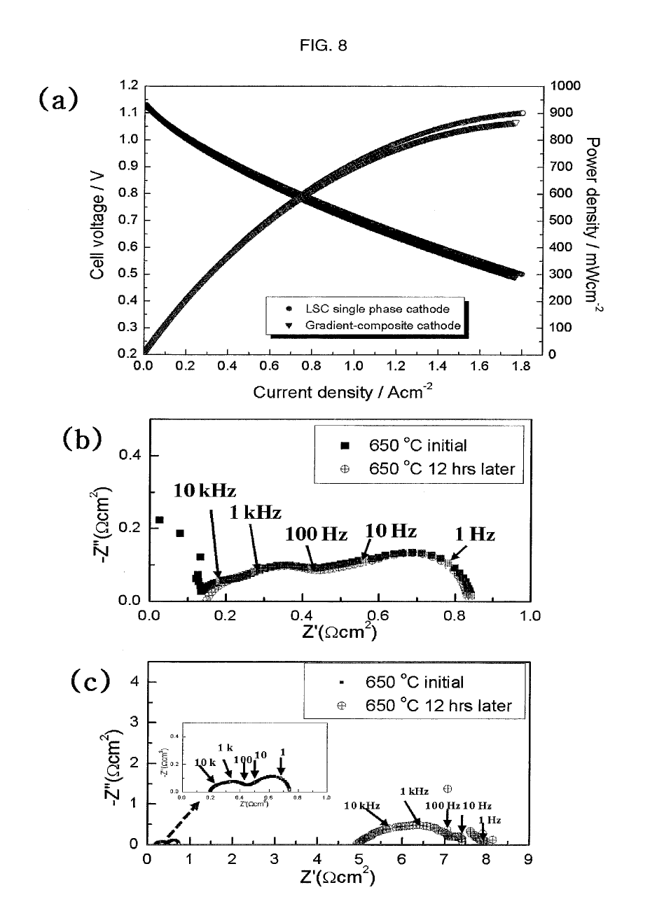

The performance and long-term stability of the cell with the GSTF cathode were compared with those of the cell with an LSC single-phase cathode. In FIG. 8 (a), the I-V-P curves of the two cells at 650° C. are compared. Before testing at 650° C., both cells were subjected to one thermal cycle from 600° C. to 450° C. The performances at each temperature are listed in Table 2.

TABLE 2

Power density (mW/cm²) at 0.7 V (values in
parentheses are those after a thermal cycle)

| Temperature | Cell with LSC single- | Cell with |
|---|---|---|
| (° C.) | phase cathode | GSTF cathode |
| 650 | 730 | 696 |
| 600 | 420 (393) | 379 (382) |
| 550 | 219 | 191 |
| 500 | 88 | 80 |
| 450 | 26 | 26 |

The performance of the cell with single-phase LSC was slightly higher but the difference was not substantial, and this indicates that the composite layer did not significantly deteriorate the cell performance. However, the performance of the cell with the single-phase cathode at 600° C. showed degradation after a thermal cycle. On the contrary, the cell with the GSTF cathode showed practically no change in the cell performance at 600° C. after the thermal cycle. To confirm the stability, the cell with the GSTF cathode was held at 600° C. for 9 hours before raising temperature to 650° C., and almost no degradation was exhibited in both I-V-P and IS.

The stability of the cell was remarkably improved by using the GSTF cathode at 650° C. In FIG. 8 (b), the IS of the cell with the GSTF cathode at 650° C. after 1 hour and 12 hours are compared. The two spectra were almost identical and no significant deterioration was observed. On the other hand, the cell with a single-phase cathode showed an approximately 10 times of impedance increment after 12 hours (FIG. 8 (c)). The inventors conducted experiments multiple times to check the consistency of the result on the high temperature stability of the GSTF cathode and single-phase cathode, and it turned out that the noticeable increase in the impedance occurred around 15-16 hours in the cell with the GSTF cathode and the same started around 7-8 hours in the cell with the single-phase cathode.

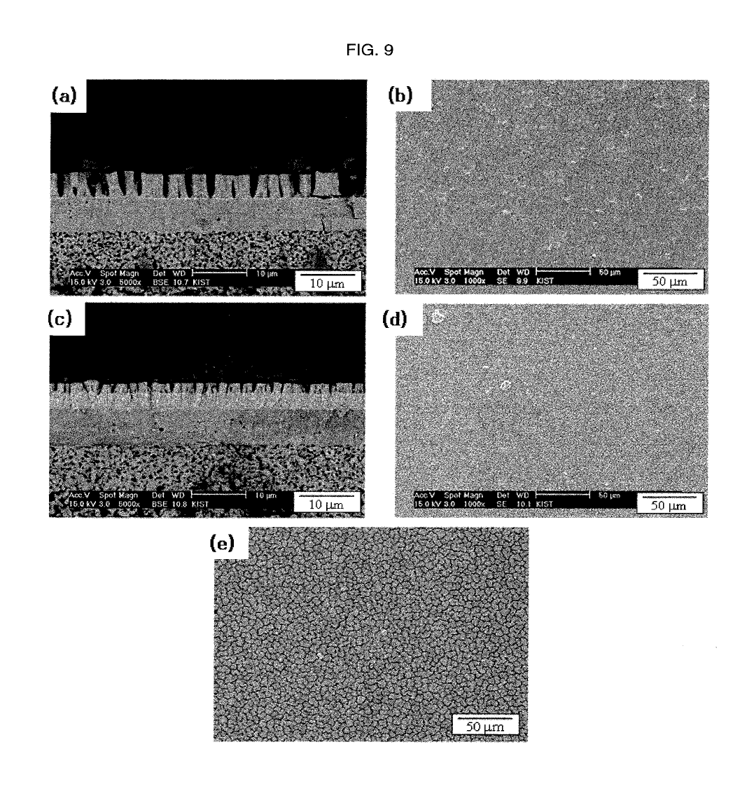

The difference in performance originated from the microstructural stability. In FIG. 9 (a)-(d), the cathode microstructures after the cell test are shown. As can be seen in FIGS. 9 (a) and (b), the cathode domains were considerably delaminated and lost in the cell with the single-phase cathode. For comparison, surface morphology of the single-phase LSC cathode before the cell test is shown in FIG. 9 (e). It is clearly shown that the domain loss due to the delamination occurred during the long-term cell test.

The microstructural degradation was severer than previously reported because the cell was subjected to the high temperature much longer during the long-term test. When the delamination and loss of the cathode domains occurred, loss of the lateral conduction in the cathode, reduction of the effective cathode area, and decrease of the cathode/electrolyte interface area arose.

The first factor affects the ohmic resistance by impeding the current collection, and the last factor influences the polarization resistance since the sites for charge transport across the cathode/electrolyte interface is eliminated. The second factor, i.e. the reduction of the electrode area, increases both ohmic and polarization resistances. On the other hand, the microstructure of the GSTF cathode did not degrade much (FIGS. 9 (c) and (d)), even though it was held in the test chamber much longer than the cell of the single-phase cathode (as previously mentioned, the cell with the GSTF cathode was kept for additional 9 hours in 600° C.).

The results suggest that it is certainly effective to insert the composite layer to improve the high temperature stability of the nano-structure cathode through enhancing the interfacial quality by means of controlling the deposition condition and suppressing TEC mismatch.

It is expected that the improved interfacial strength would enable to raise the total thickness of the thin-film-processed cathode, which was proven to be effective in increasing the cell performance. By fabricating the LSC-GDC nano-composite thin-film cathode by PLD, the microstructural stability of the thin film could be significantly improved. The defects due to the TEC mismatch was suppressed in the composite layer compared with the single-phase LSC layer when deposited at high temperature. By changing the ambient deposition pressure, the porosity of the composite layer could be controlled and this yielded much improved stability of the high-temperature performance and structure.

Unlike the single-phase LSC cathode that showed significant degradation after 7-8 hours of operation at 650° C., the GSTF cathode did not exhibit noticeable degradation after the long-term operation for 9 hours at 600° C. and for 12 hours at 650° C. Microstructures of the cathodes revealed that the performance stability originated from the improved interfacial quality of the GSTF cathode.

### Example 2

### LSM-YSZ Composite Electrode

A half cell for a cathode was fabricated by depositing 200-nm thick GDC on a 2 cm×2 cm anode support on which 8-μm thick YSZ electrolyte had been formed. Then, an LSM-YSZ composite target was ablated by PLD to form an LSM-YSZ nanocomposite thin film. The composite target was prepared by sintering compacted LSM ((La_{0.7}Sr_{0.3})_{0.95}MnO_{3-δ}, Seimi Chemical Co.) and YSZ (8 mol % Y₂O₃-doped ZrO₂, TZ-8Y, Tosoh Corp.) powder mixture (mass ratio=1:1, volume ratio=48:52) at 1,200° C. for 3 hours.

To prepare a nanocomposite cathode thin film, a KrF excimer laser (λ=248 nm, COMPEX Pro 201F, Coherent) was radiated on the composite target. The fluence at the target surface was approximately 2.5 J/cm², and the target to substrate distance was fixed at 5 cm.

To form a gradient-structured LSM-YSZ cathode, a 1-μm thick LSM-YSZ layer was deposited at 26.66 Pa and a 2-μm thick LSM-YSZ layer was deposited at 39.99 Pa thereabove. It is to form a gradient structure with porosity increasing from the electrolyte/cathode interface toward the upper portion of the cathode utilizing the principle that the porosity increases at higher deposition pressure. The deposition was performed at a substrate temperature of 700° C.

A 2-μm thick LSC layer was formed at the upper portion of the composite cathode as a current collecting layer. The LSC layer was formed by depositing at room temperature and 13.33 Pa and then post-annealing at 650° C. for 1 hour. During the PLD deposition, oxygen was used as ambient gas.

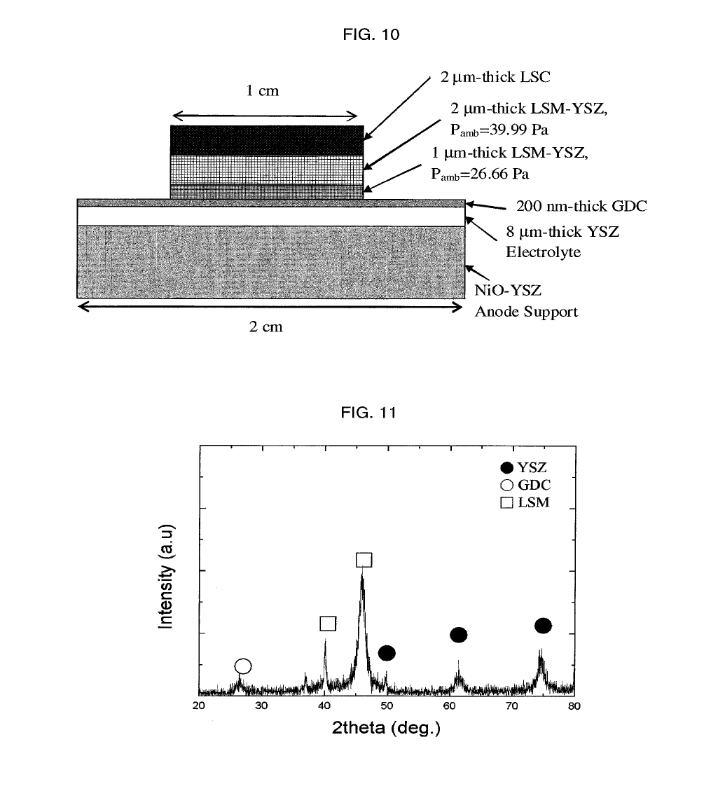

FIG. 10 schematically shows cross-sectional structure of the SOFC single cell fabricated in this example. Electrochemical characterization of the single cell was conducted by using a Solartron impedance analyzer with an electrochemical interface (SI1260 and SI1287). Measurement setup and conditions were identical to those for the LSM cathode SOFC. Phase and microstructure of cathode were analyzed by X-ray diffraction (XRD; PW3830, PANalytical) analysis and scanning electron microscopy (SEM; XL-30 FEG, FEI).

XRD Analysis Result

FIG. 11 shows an XRD analysis result of the fabricated single cell. YSZ and LSM diffraction peaks are clearly discernible although other peaks also appear since the cell is multi-layered. The peak of LSC overlaps with that of LSM. The XRD analysis result confirms that an LSM/YSZ composite layer was obtained. Thus, it was confirmed that a uniformly-mixed composite thin film with the two materials that do not react with or dissolve each other could be obtained by PLD.

Surface and Cross-Sectional Microstructure

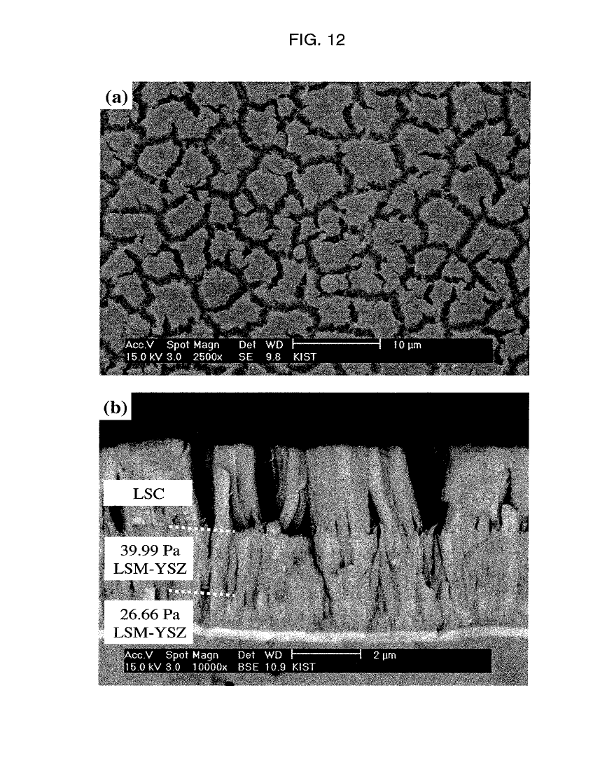

Surface morphology and cross-sectional microstructure of the cathode are shown in FIGS. 12 (a) and (b), respectively. The microstructure of the LSC current collecting layer on the surface is identical to that of the LSC layer shown in Example 1. As a consequence of the deposition at low temperature and high pressure followed by post-annealing, crack-like vertical void structures were formed by local sintering shrinkage.

Similarly to the gradient structure of the LSC-GDC of Example 1, the cross-sectional microstructure was relatively dense for the LSM-YSZ layer deposited at 26.66 Pa and more porous for the LSM-YSZ layer deposited at 39.99 Pa. The uppermost LSC current collecting layer had the highest porosity as intended.

The difference of the cathode fabricated in this example from the cathode only with LSM can be summarized as i) change from LSM single material to LSM-YSZ composite, and ii) increased thickness of the LSM electrode layer from 1 μm to 3 μm.

Measurement of Electrochemical Performance

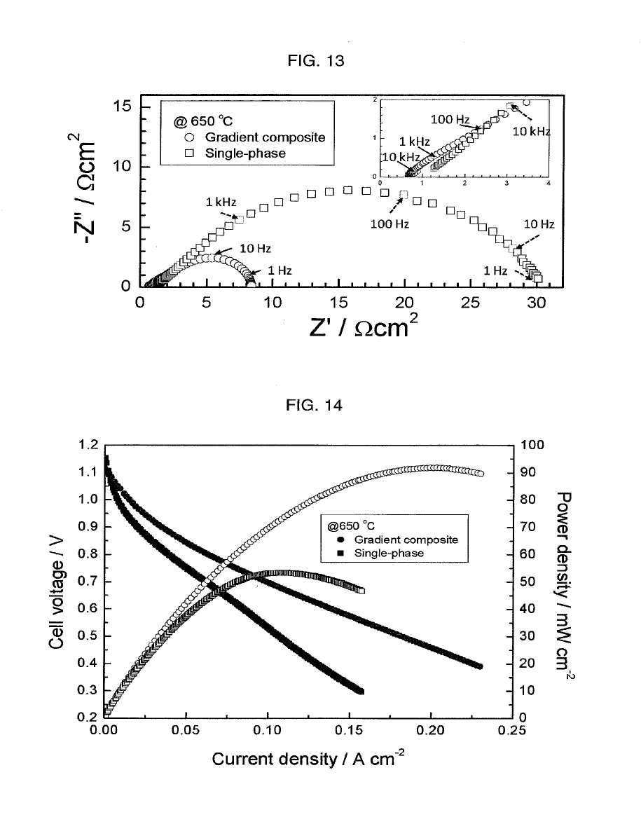

In order to investigate the effect of the change on electrochemical performance, result of impedance measurement for the two single cells at 650° C. is compared in FIG. 13. The most noticeable change is that the impedance arc at high frequencies above 10 Hz degreased significantly for the gradient-structured composite cathode. The impedance arc at high frequencies is related with reactions at the electrode, i.e. reduction of oxygen and charge transfer between the electrode and the electrolyte. Since the two cathodes are identical in cathode and electrolyte materials, the increased electrode activity is owing to the increased reaction sites for the electrode reactions, i.e. increased TPB. It is evident that the change from the LSM single material to the LSM-YSZ together with the increased thickness resulted in increase of TPB along the thickness direction of the cathode.

Further, the increased cathode thickness seems to improve not only polarization resistance but also ohmic resistance. The insert of FIG. 13 shows magnification of the portion of ohmic polarization. It can be seen that the ohmic area specific resistance (ASR) decreased from 1.2 to 0.7 Ω·cm² as the LSM single material is changed to the gradient-structured composite cathode. The increase in the area for electrical conduction along the lateral direction of the cathode (increase in the cross-sectional area perpendicular to the electrode) owing to the increased cathode thickness seems to have led to such results via reduced electrical resistance.

Especially, in the several-micrometer thick thin-film electrode, wherein the loss of conductivity in the lateral direction may be great, the increased electrode thickness may have a greater effect on the ohmic resistance.

The polarization resistance of the two single cells is compared in Table 3 (ASR was measured at 650° C.). The polarization resistance and ohmic resistance of the gradient-structured LSM-YSZ composite cathode decreased by about 30% and about 60%, respectively, when compared with the LSM cathode. The change in the polarization resistance affected the single cell performance.

TABLE 3

| | Ohmic ASR | Polarization ASR |
|---|---|---|
| | (Ω · cm²) | (Ω · cm²) |
| Cell with gradient-structured | 0.7 | 8.4 |
| composite cathode | | |
| Cell with single LSM cathode | 1.2 | 28.9 |

In FIG. 14, current-voltage-power (I-V-P) curves of the cell having the gradient-structured composite cathode and the cell having the single-phase LSM cathode are compared at 650° C. As shown in Table 4 below, the cell output performance increased by 1.6 times when the gradient-structured composite cathode was used. From the I-V-P curves, a less decrease in voltage is observed at low current density region (0-0.25 Acm⁻²) when the composite cathode was used. This can be explained by the decreased polarization due to improved electrode activity of the cathode. Also, the appreciable difference in the slopes of the region where the I-V-P curves show linear behaviors where the ohmic resistance is dominant reveals that the use of the composite cathode with increased thickness results in decreased ohmic resistance and thus affects the cell performance.

TABLE 4

| | Power density @ | Maximum power |
|---|---|---|
| | 0.7 V (Wcm⁻²) | density (Wcm⁻²) |
| Cell with gradient-structured | 69 | 92 |
| composite cathode | | |
| Cell with single LSM cathode | 43 | 53 |

In accordance with the present disclosure, an electrode-electrolyte composite with the electrode and electrolyte materials mixed in molecular scale is formed, and mixing ratio, porosity, grain size, thickness, etc. can be controlled freely by controlling the deposition condition. As a result, a composite electrode with nano-sized grains can be formed to have a nanoporous structure. This remarkably improves specific surface area and catalytic activity and thus allows to prepare a cathode with high electrode catalytic activity even at low operation temperature.

Since the difference in thermal expansion coefficient with the electrolyte can be adjusted by varying the electrode/electrolyte mixing ratio, interfacial failure due to thermal expansion coefficient mismatch can be prevented. Further, since aggregation of single material can be inhibited by the use of the composite material, the resulting electrode has better structural stability than the single-phase nanostructure electrode at the operation temperature of the SOFC.

Especially, since the structure is applicable to mass-production process such as thin-film deposition, the disclosed technique is applicable and extendable to other applications and is highly compatible with other techniques. For example, it may be applicable to sensors, membranes, etc. requiring nanocomposite electrodes, as well as SOFCs.

Furthermore, since the SOFC according to the present disclosure is operable at low temperature, various materials may be used. And, since the problems occurring at high temperature can be avoided, the SOFC is excellent in terms of economy and reliability. In particular, since the cathode of the present disclosure can be prepared into a thickness of 1 μm or smaller without the problem of deformation of the electrolyte structure, the operation temperature can be further decreased by using the thin-film electrolyte.

The operation at low temperature allows for miniaturized SOFCs owing to reduced burden of heat management. Such miniaturized SOFCs will be of great economic value by replacing the existing mobile power sources with high energy density and output performance.

While the present disclosure has been described with respect to the specific embodiments, it will be apparent to those skilled in the art that various changes and modifications may be made without departing from the spirit and scope of the disclosure as defined in the following claims.

What is claimed is:

1. A solid oxide fuel cell comprising:
an anode support;
a solid electrolyte layer formed on the anode support; and
a nanostructure composite cathode layer formed on the solid electrolyte layer,
wherein the nanostructure composite cathode layer comprises an electrode material and an electrolyte material mixed in molecular scale, which do not react with each other or dissolve each other to form a single material.

2. The solid oxide fuel cell of claim 1, wherein the electrode material of the composite cathode layer is at least one selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate.

3. The solid oxide fuel cell of claim 1, wherein the electrolyte material is selected from a group consisting of yttria-stabilized zirconia (YSZ), scandia-stabilized zirconia (ScSZ), gadolinia-doped ceria (GDC), samaria-doped ceria, doped barium zirconate (BaZrO₃) and barium cerate (BaCeO₃).

4. The solid oxide fuel cell of claim 1, wherein the proportion of the electrode material and the electrolyte material of the composite cathode layer is from 2:8 to 8:2.

5. The solid oxide fuel cell of claim 1, wherein the anode support comprises a material selected from a group consisting of NiO-YSZ, NiO—ScSZ, NiO-GDC, NiO-SDC NiO-doped BaZrO₃, Ru, Pd, Rd and Pt.

6. The solid oxide fuel cell of claim 1, wherein the composite cathode layer has a grain size of 100 nm or smaller.

7. The solid oxide fuel cell of claim 1, which further comprises a single-phase current collecting layer on the composite cathode layer.

8. The solid oxide fuel cell of claim 1, which further comprises a buffer layer between the electrolyte layer and the composite cathode layer.

9. The solid oxide fuel cell of claim 1, wherein the composite cathode layer comprises two or more layers.

10. The solid oxide fuel cell of claim 1, wherein the composite cathode layer has a porosity-gradient structure with porosity increasing from the side contacting with the electrolyte layer toward the upper portion.

11. The solid oxide fuel cell of claim 1, wherein the composite cathode layer has a composition-gradient structure with the content of the electrode material increasing from the side contacting with the electrolyte layer toward the upper portion.

12. A method for fabricating a solid oxide fuel cell, comprising:
forming a solid electrolyte layer on an anode support; and
forming a nanostructure composite cathode layer wherein an electrolyte material and an electrode material are mixed in molecular scale on the solid electrolyte layer.

13. The method for fabricating a solid oxide fuel cell according to claim 12, wherein the composite cathode layer is formed by a deposition method selected from pulsed laser deposition (PLD), sputter deposition, electron beam evaporation deposition, thermal evaporation deposition, chemical vapor deposition (CVD) and electrostatic spray deposition.

14. The method for fabricating a solid oxide fuel cell according to claim 13, wherein the composite cathode layer is deposited at 200-1,000° C. and at pressure of 10 Pa or higher.

15. The method for fabricating a solid oxide fuel cell according to claim 12, which further comprises, after said forming the composite cathode layer, forming a single-phase current collecting layer on the composite cathode layer.

16. The method for fabricating a solid oxide fuel cell according to claim 12, which further comprises, before said forming the composite cathode layer, forming a buffer layer between the electrolyte layer and the composite cathode layer.

17. The method for fabricating a solid oxide fuel cell according to claim 12, wherein the composite cathode layer comprises two or more layers.

18. The method for fabricating a solid oxide fuel cell according to claim 17, wherein the multi-layered composite cathode layer has a porosity-gradient structure with porosity increasing from the side contacting with the electrolyte layer toward the upper portion.

19. The method for fabricating a solid oxide fuel cell according to claim 18, wherein the porosity-gradient structure is formed by forming an n-th composite cathode layer (n is an integer 1 or larger) and then forming an (n+1)-th composite cathode layer with porosity higher than that of the n-th composite cathode layer by increasing deposition pressure.

20. The method for fabricating a solid oxide fuel cell according to claim 18, wherein the porosity-gradient structure is formed by forming an n-th composite cathode layer (n is an integer 1 or larger) and then forming an (n+1)-th composite cathode layer with porosity higher than that of the n-th composite cathode layer by lowering deposition temperature.

21. The method for fabricating a solid oxide fuel cell according to claim 17, wherein the multi-layered composite cathode layer has a composition-gradient structure with the content of the electrode material increasing from the side contacting with the electrolyte layer toward the upper portion.

22. The method for fabricating a solid oxide fuel cell according to claim 21, wherein the composition-gradient structure is formed by controlling the composition of a composite target comprising the electrode material and the electrolyte material when depositing the composite cathode layer using the composite target.

23. The method for fabricating a solid oxide fuel cell according to claim 21, wherein the composition-gradient structure is formed by controlling laser power, pulse or sputter power for each electrode target material and electrolyte target material when depositing the composite cathode layer using the target materials.

24. The method for fabricating a solid oxide fuel cell according to claim 12, which further comprises, after said forming the composite cathode layer, conducting post-annealing to improve adhesion to thin film and crystallinity.

25. The method for fabricating a solid oxide fuel cell according to claim 12, wherein the electrode material of the composite cathode layer is at least one selected from a group consisting of lanthanum strontium manganite (LSM), lanthanum strontium ferrite (LSF), lanthanum strontium cobaltite (LSC), lanthanum strontium cobalt ferrite (LSCF), samarium strontium cobaltite (SSC), barium strontium cobalt ferrite (BSCF) and bismuth ruthenate.

26. The method for fabricating a solid oxide fuel cell according to claim 12, wherein the electrolyte material is selected from a group consisting of yttria-stabilized zirconia (YSZ), scandia-stabilized zirconia (ScSZ), gadolinia-doped ceria (GDC), samaria-doped ceria, doped barium zirconate (BaZrO₃) and barium cerate (BaCeO₃).

27. The method for fabricating a solid oxide fuel cell according to claim 12, wherein the proportion of the electrode material and the electrolyte material of the composite cathode layer is from 2:8 to 8:2.

28. The method for fabricating a solid oxide fuel cell according to claim 12, wherein the composite cathode layer has a grain size of 100 nm or smaller.
